(19) United States
(12) Patent Application Publication
(10) Pub. No.: US 2008/0186084 A1
(43) Pub. Date: Aug. 7, 2008

(54) VOLTAGE STABILIZING CIRCUIT FOR CHIPS AND METHOD THEREOF

(75) Inventors: Yi-Lin Chen, Taipei City (TW); Tung-Cheng Kuo, Hsinchu City (TW)

Correspondence Address: ROSENBERG, KLEIN & LEE, 3458 ELLICOTT CENTER DRIVE-SUITE 101, ELLICOTT CITY, MD, 21043, US

(73) Assignee: REALTEK SEMICONDUCTOR CORP., HSINCHU CITY (TW)

(21) Appl. No.: 12/022,434

(22) Filed: Jan. 30, 2008

(30) Foreign Application Priority Data
Feb. 1, 2007 (TW) 096103754

(51) Int. Cl. G05F 3/16; G05F 3/02

(52) U.S. Cl. 327/543; 327/538

(57) ABSTRACT

A voltage stabilizing circuit for chips and the method thereof are disclosed. The circuit and the method thereof are applied to chips with at least one non-wire bonded I/O circuit. The driver circuit of the I/O circuit includes a plurality of transistors. The method of voltage stabilizing involves causing at least one of these transistors to start conducting in order to generate a stabilizing capacitor. Therefore, chip damages caused by voltage or current fluctuations can be avoided, simultaneously reducing the cost and the amount of chip surface area being consumed.

### BACKGROUND OF THE INVENTION

The present invention relates to voltage stabilizing, especially to a voltage stabilizing circuit and a voltage stabilizing method for chips.

With the development of system on chip (SOC) integrated circuits in the semiconductor industry, the size of metal-oxide-semiconductor field-effect transistor (MOSFET) components has shifted from a submicron era to a deep submicron era. Therefore, it is one of the goals of semiconductor manufacturers to make components function effectively and efficiently within the limited surface area of the chip.

Due to the trend of smaller size of MOSFETs, their components tend to be sensitive to voltage or current fluctuations and may get damaged. Therefore, in order to protect the components, a bulk capacitor that immediately provides protection for any fluctuations is disposed inside the chip. Moreover, the ground bounce effect caused by a voltage difference between the device and the board ground is also minimized by controlling the parasitic inductance. A stabilizing capacitor is generally made with the gate electrode of the MOSFET. This consumes a large surface area of the chip. Another method is to use a metal-metal capacitor. However, the effectiveness of such a parasitic capacitor is considerably less than that of the MOSFET. A further method is to use a metal-insulator-metal (MIM) capacitor. Although such a capacitor is more effective than the metal-metal capacitor, it is still not as good as a MOSFET; further, its manufacturing process is quite complicated.

Thus, there is a need to provide a new method for voltage stabilizing that not only prevents chip damages caused by voltage or current fluctuations but also reduces the amount of chip surface area being consumed.

### SUMMARY OF THE INVENTION

It is a primary object of the present invention to provide a voltage stabilizing circuit for chips and a method thereof that uses the driver circuit of a non-wire bonded I/O circuit as a stabilizing capacitor in order to avoid chip damages caused by voltage or current fluctuations.

It is a further object of the present invention to provide a voltage stabilizing circuit for chips and the method thereof that uses the driver circuit of a non-wire bonded I/O circuit as a stabilizing capacitor for reducing the amount of chip surface area being consumed as well as reducing the cost.

A voltage stabilizing circuit for chips according to the present invention is applied to non-wire bonded chips with at least one non-wire bonded I/O circuit. The driver circuit of the I/O circuit includes a plurality of transistors. The method of voltage stabilizing involves causing at least one of these transistors to start conducting in order to generate a stabilizing capacitor. The transistors include a p-channel MOSFET and an n-channel MOSFET connected in series.

### BRIEF DESCRIPTION OF THE DRAWINGS

The structure and the technical means adopted by the present invention to achieve the above and other objects can be best understood by referring to the following detailed description of the preferred embodiments and the accompanying drawings:

FIG. 1 is a block diagram of an embodiment according to the present invention, and

FIG. 2 is a circuit diagram of an embodiment according to the present invention.

### DETAILED DESCRIPTION OF THE PREFERRED EMBODIMENT

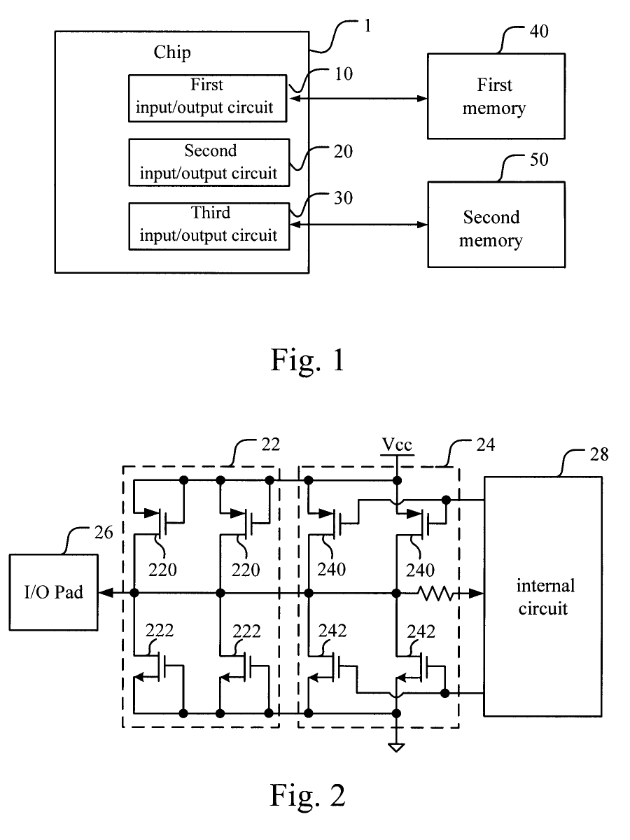

Referring to FIG. 1, chip 1 consists of first input/output (I/O) circuit 10, second input/output (I/O) circuit 20, and third input/output (I/O) circuit 30. Circuit 20 is coupled to first memory 40, while circuit 30 is coupled to second memory 50. In system integration technology, the number of wire bondings required for connecting pins on chip 1 depends on users needs while designing chip 1. In this embodiment, the method of voltage stabilizing is by using the second input/output (I/O) circuit 20 that has no wire bonding on chip 1. By using the unused component of chip 1 (the second input/output (I/O) circuit 20) for voltage stabilizing, cost is reduced since the amount of chip 1 surface area being consumed does not increase. The figure illustrated is only an embodiment, it is thereby not necessary for chip 1 to be coupled with the first memory 40 or the second memory 50 in general designs.

FIG. 2 is an embodiment illustrating the I/O circuit of chip 1 according to the present invention. The embodiment is composed of electrostatic discharge (ESD) protection circuit 22, I/O driver circuit 24, I/O pad 26, and internal circuit 28. In the present invention, the I/O circuit is used to stabilize the voltage. Circuit 24 is coupled between circuit 22 and circuit 28 of chip 1 for receiving and transmitting signals. The non-wire bonded I/O circuit is less useful to chip 1 when circuit 24 is set in an input mode. This implies that circuit 24 is turned off. Furthermore, chip 1 tends to generate parasitic inductance after packaging, causing voltage fluctuations and consequently causing damages to the chip. Consider a quad flat pack (QFP) or a ball grid array (BGA) as an example. The parasitic inductance effect generated by the QFP is far more marked than that generated by the BGA. Thus, when the I/O circuit is non-wire bonded, the spare circuit 24 is set in an output mode. By a level voltage that conducts some of the transistors, the capacitor of circuit 24 is used as the stabilizing capacitor for stabilizing the voltage.

In an embodiment of the present invention, circuit 24 includes a plurality of transistors with p-channel MOSFET 240 and n-channel MOSFET 242 connected in series. Circuit 28 inside chip 1 sets circuit 24 in an output mode. The high level signal “1” and low level signal “0” are simultaneously transmitted to circuit 24 for causing either p-channel MOSFET 240 or n-channel MOSFET 242 to start conducting. When one of the MOSFETs starts conducting, the other is turned off. Thus, the MOSFET is used as a stabilizing capacitor for preventing damages to the chip caused by voltage or current fluctuations. The high level signal “1” or low level signal “0” can be provided by using a dual level voltage circuit.

In addition, in a further embodiment of the present invention, circuit 24 includes sets of p-channel MOSFET 240 and n-channel MOSFET 242 connected in series in order to increase the capacity of the voltage stabilizing capacitor of chip 1. Generally, chip 1 includes more than one set of the non-wire bonded I/O circuit. This enables the stabilization of voltage signals inputted to chip 1. By using a non-wire bonded I/O circuit for stabilizing the voltage, the amount of chip 1 surface area being consumed is saved; therefore, the cost is further reduced.

In summary, a voltage stabilizing circuit and the method thereof according to the present invention are applied to chips with at least one non-wire bonded I/O circuit. By causing one of the MOSFETs of the driver circuit of the I/O circuit to start conducting, a stabilizing capacitor is generated.

Additional advantages and modifications will readily occur to those skilled in the art. Therefore, the invention in its broader aspects is not limited to the specific details and representative devices shown and described herein. Accordingly, various modifications may be made without departing from the spirit or scope of the general inventive concept, as defined by the appended claims and their equivalents.

What is claimed is:

1. A voltage stabilizing circuit for chips comprising:
an I/O driver circuit having a plurality of transistors; and
a level voltage for causing at least one of the transistors to start conducting;
wherein the I/O driver circuit is the I/O driver circuit without any wire bonding of the chip.

2. The voltage stabilizing circuit as claimed in claim 1 wherein the transistors include at least one set of p-channel and n-channel MOSFETs connected in series.

3. The voltage stabilizing circuit as claimed in claim 2 wherein either the p-channel or the n-channel MOSFET starts conducting.

4. The voltage stabilizing circuit as claimed in claim 2 wherein the p-channel MOSFET starts conducting, while the n-channel MOSFET is turned off.

5. The voltage stabilizing circuit as claimed in claim 2 wherein the p-channel MOSFET is turned off, while the n-channel MOSFET starts conducting.

6. The voltage stabilizing circuit as claimed in claim 2 wherein the p-channel and the n-channel MOSFETs simultaneously receive either a high level or a low level voltage input.

7. The voltage stabilizing circuit as claimed in claim 1 wherein the chip is packaged in a quad flat pack.

8. The voltage stabilizing circuit as claimed in claim 1 wherein the I/O driver circuit is set in an output mode.

9. A voltage stabilizing method for chips having at least one non-wire bonded I/O driver circuit formed by a plurality of transistors, comprising the following steps:
causing at least one of the transistors to start conducting; and
turning off the other transistor.

10. The voltage stabilizing method as claimed in claim 9 wherein the transistors comprise at least one set of p-channel and n-channel MOSFETs connected in series.

11. The voltage stabilizing method as claimed in claim 10 wherein the p-channel MOSFET starts conducting, while the n-channel MOSFET is turned off.

12. The voltage stabilizing method as claimed in claim 10 wherein the p-channel MOSFET is turned off, while the n-channel MOSFET starts conducting.

13. The voltage stabilizing method as claimed in claim 10 wherein the p-channel and the n-channel MOSFETs simultaneously receive either the high level or the low level voltage input.

14. The voltage stabilizing method as claimed in claim 9 wherein the chip is packaged in a quad flat pack.

15. The voltage stabilizing method as claimed in claim 9 wherein the method further comprises the following step:
setting the I/O driver circuit in an output mode.
